(19) United States
(12) Patent Application Publication
(10) Pub. No.: US 2003/0171090 A1
(43) Pub. Date: Sep. 11, 2003

(54) Room ventilating apparatus

(76) Inventor: Mohammad Ali Shaikh, Jersey City, NJ (US)

Correspondence Address: Attention: Dennis M. Smid, Esq., FROMMER LAWRENCES & HAUG LLP, 745 Fifth Avenue, New York, NY, 10151, US

(21) Appl. No.: 10/391,389

(22) Filed: Mar. 18, 2003

Related U.S. Application Data
(62) Division of application No. 10/041,240, filed on Jan. 8, 2002.

(51) Int. Cl. F24F 7/00; F24F 11/00; F23J 11/00; F24F 13/00; B08B 15/02; F24C 15/20; B60H 1/24

(52) U.S. Cl. 454/66; 454/67; 454/162; 126/299 D

(57) ABSTRACT

A room ventilator for venting smoke exhaled by a smoker from a room to an exterior location. The room ventilator has an intake unit located in the room for drawing in smoke exhaled by the smoker, an air pump for producing an air flow to draw the smoke into the intake unit and exhausting the smoke to the exterior location, a connecting tube for connecting the intake unit to the air pump, and a window outlet adjuster for mounting in a window which enables a connecting tube to pass from the room to the exterior location. The window outlet adjuster has adjustable flaps for forming a barrier between the room and the exterior. Another embodiment is a ventilating unit having first and second sensors for respectively detecting the presence of first and second air pollutants at an interior location and starting an air pump when at least one of the first and second air pollutants is detected, an intake unit for drawing in the detected air pollutants, and a duct connecting the intake unit to the exterior for venting the detected air pollutants.

### BACKGROUND OF THE INVENTION

The present invention relates generally to a ventilation unit for venting smoke and other air pollutants from an interior location to an exterior location.

The health issues relating to indoor air pollutants are well documented. Such air pollutants may include cigarette smoke, dust, mold, pet dander, natural gas, radon gas, chemical fumes, noxious odors, etc . . . Depending on the pollutant, health concerns may range from minor allergies to asphyxiation and even death. Recently, there has been increased concern over the hazards associated with secondhand smoke. Because of these concerns, smokers are often forced to choose between not smoking and leaving the locale to smoke (i.e. going outside to smoke).

Moreover, in many indoor environments, air flow from the exterior is limited and the interior air is often recirculated. This is especially true if it is desirable to isolate/insulate the occupants from the exterior environment. For example, buildings may be well insulated to conserve on the cost of heating/air conditioning. As another example, automobiles may also be constructed to isolate occupants from ambient road noises. Due to the lack of fresh air flow and/or the recirculating of interior air, air pollutants can build up and become trapped.

### SUMMARY OF THE INVENTION

Therefore, a need exists for ventilating air pollutants from localized indoor locations, preferably to an exterior location. A ventilation system is needed that allows smokers to smoke indoors without disturbing and/or endangering the health of others who may be in close proximity. Such a system is not only a convenience for smokers, but also provides health benefits by ensuring a cleaner environment for everyone.

Recent concerns over indoor air quality have accentuated the need for ventilation systems to remove air pollutants such as secondhand smoke. Such systems should be unobtrusive, simple to use, and effective.

A first embodiment of the present invention provides a room ventilator for venting smoke exhaled by a smoker from a room to an exterior location. The room ventilator has an intake unit located in a room for drawing in smoke exhaled by the smoker, an air pump for producing an air flow to draw the smoke into the intake unit and exhausting the smoke to the exterior location, connecting means including at least one connecting tube for connecting the intake unit to the air pump, and a window outlet adjuster for mounting in a window which enables the connecting tube to pass from the room to the exterior location. The window outlet adjuster has adjustable flaps for forming a barrier between the room and the exterior.

In the first embodiment, the intake unit may be located proximate to the head of the smoker and the air pump may be located at either the exterior location or within the room. The room ventilator may further include a floor stand for supporting the intake unit proximate to the head of the smoker and/or a variable switch for controlling the air flow produced by the air pump. The window outlet adjuster may have adjustable vents to allow air to flow between the room and the exterior. The connecting tube may be flexible or rigid and be made from a hose, tube, pipe or duct.

A second embodiment of the present invention provides a ventilating unit for detecting and venting air pollutants from a room to an exterior location. The ventilating unit has first and second sensors for respectively detecting the presence of first and second air pollutants at an interior location and starting an air pump when at least one of the first and second air pollutants is detected, an intake unit for drawing in the detected air pollutants, and a duct connecting the intake unit to the exterior for venting the detected air pollutants.

In the second embodiment, the first and second sensors may include two of a natural gas sensor, a smoke sensor, an odor sensor, a carbon monoxide sensor, and/or a radon sensor. The sensors may also produce an alarm signal when air pollutants are detected. The ventilating unit may further include a fresh air pump for producing an air inflow to draw fresh air from an exterior location to the interior.

A third embodiment of the present invention provides an automobile smoke remover for removing smoke exhaled by a smoker in an automobile. The automobile smoke remover has an articulated arm mounted within the automobile. The articulated arm has at least a retracted position and an extended position. An intake unit is mounted on the articulated arm and is located proximate to the head of the smoker for drawing in smoke exhaled when the articulated arm is in the extended position. An air pump automatically produces an air flow when the articulated arm is placed in the extended position and automatically stops producing the air flow when the articulated arm is placed in the retracted position. A connecting tube connects the intake unit to the outside through which the air flow passes such that the smoke drawn into the intake unit is vented to the outside of the automobile.

In the third embodiment, the automobile smoke remover may additionally include a window outlet adjuster mounted in a window of the automobile and connected to the connecting tube to exhaust the smoke from the automobile. Further, the air pump may be located beneath the seat of either the driver or a passenger in the automobile to which the articulated arm is attached. The automobile smoke remover may be installed by the automobile manufacturer at the factory or may be installed as an after-market accessory.

A fourth embodiment of the present invention provides a room ventilator integrated into a table for venting smoke exhaled by a smoker from a room to an exterior location. The room ventilator has smoke suction vents for drawing in smoke exhaled by the smoker, an air suction pump for producing an air flow to draw the smoke into the smoke suction vents and exhausting the smoke to the exterior location, and a connecting pipe for connecting the smoke suction vents to the air suction pump. The smoke suction vents may retract into the tabletop when not in use.

In the fourth embodiment, the retracting action for the smoke suction vents can be manual or spring/motor actuated. A switch may be provided for each smoke suction vent for controlling the air flow produced by the air suction pump and/or the retraction mechanism.

A fifth embodiment of the present invention provides a room ventilator mounted into a wall for venting smoke exhaled by a smoker from a room to an exterior location. The room ventilator has a smoke suction vent for drawing in smoke exhaled by the smoker, an air suction pump mounted in a wall unit for producing an air flow to draw the smoke into the smoke suction vent and exhausting the smoke to the exterior location, and a moveable connecting pipe for connecting the smoke suction vent to the air suction pump. The smoke suction vent may be adjustably coupled to the wall mounted unit using the moveable connecting pipe to be located proximate to the head of the smoker.

In the fifth embodiment, the moveable connecting pipe may be attached to the wall unit using a hinged mount that provides for multiple fixed positions of the smoke suction vent.

### BRIEF DESCRIPTION OF THE DRAWINGS

For a more complete understanding of the invention, reference is made to the following description and accompanying drawings, in which:

FIG. 1 is a diagram of a first embodiment of the present invention for indoor use;

FIG. 1A is a diagram of a modification to the first embodiment of the present invention of FIG. 1;

FIG. 2 is a diagram of a window outlet adjuster of the first embodiment of the present invention shown in FIG. 1;

FIG. 3 is a diagram of a second embodiment of the present invention for indoor use;

FIG. 4 is a diagram of a third embodiment of the present invention for use in automobiles and other vehicles;

FIG. 5 is a diagram of a fourth embodiment of the present invention for indoor use;

FIG. 6 is a diagram of a fifth embodiment of the present invention for indoor use;

FIG. 7 is a perspective drawing of aspects of the first embodiment of the present invention shown in FIG. 1; and

FIG. 7A is a detailed side view of an intake unit of the first embodiment of the present invention shown in FIG. 7.

### DETAILED DESCRIPTION OF THE PREFERRED EMBODIMENTS

The preferred embodiments of the room ventilating apparatus according to the present invention will be described with reference to the accompanying drawings.

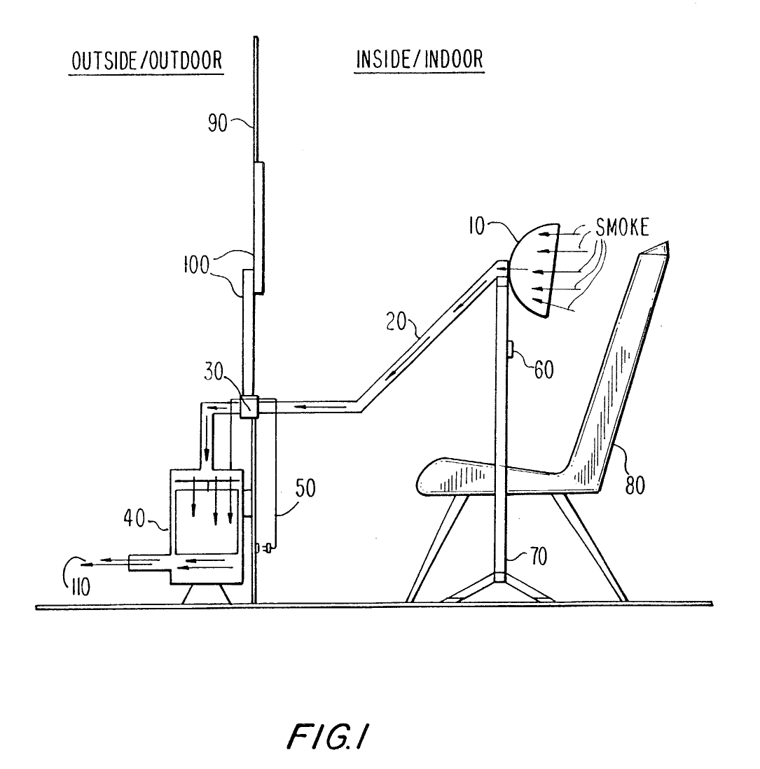

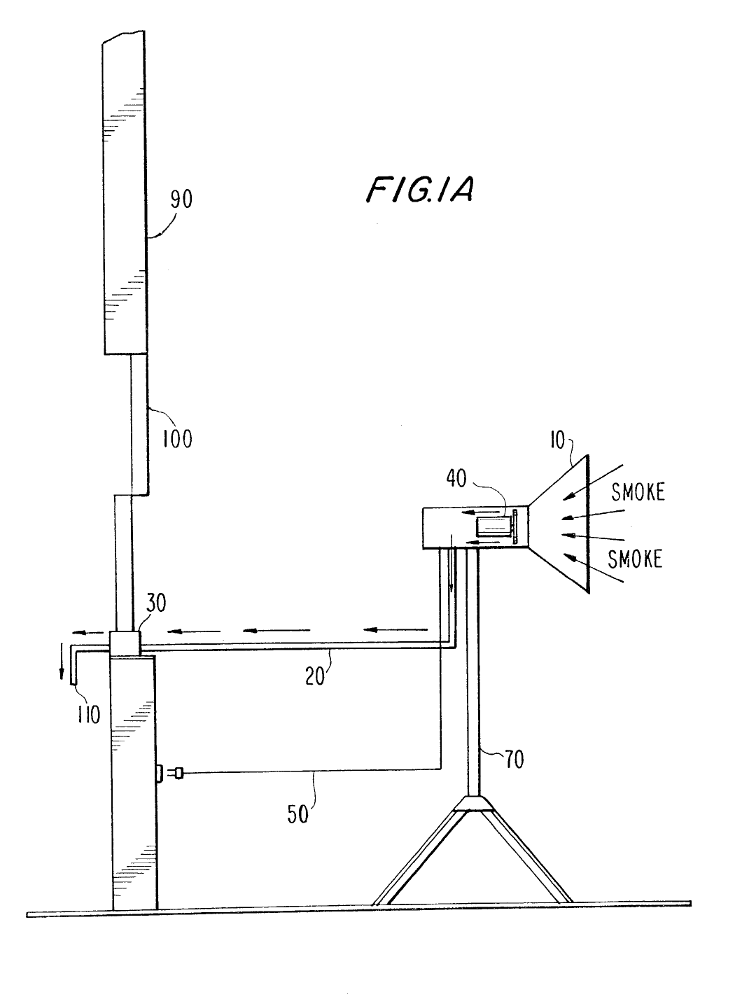

Referring to FIG. 1, a first embodiment of the invention—adapted for use indoors as a room ventilator for venting smoke exhaled by a smoker from a room to an exterior location—is shown. The room ventilator has an intake unit 10 for drawing in smoke exhaled by the smoker. The intake unit may be supported by an adjustable stand 70 so that the unit can be located proximate to the head of the smoker. An air pump 40 produces an air flow that draws the smoke into the intake unit and exhausts the smoke to the exterior location 110. A connecting tube 20 connects the intake unit to the air pump. A window outlet adjuster 30 mounted in a window 100 of the room is used to pass the connecting tube to the exterior.

The air pump 40 may be located at either the exterior location as shown or within the room (not shown). If the pump is located indoors, then the exhaust is still passed outside through the window outlet adjuster. The air pump may be set directly on the ground or mounted to either the interior or exterior of a wall 90. Alternatively, the pump may be located adjacent to intake unit 10 as shown in the modification of the first embodiment shown in FIG. 1A. The air pump is preferably an electric pump powered using a simple electrical cord 50 which may be plugged into any standard electrical receptacle. Alternatively, the air pump may be other than electrically powered (e.g. a gas or diesel pump). The air pump may also contain a filter (not shown) to filter the drawn in smoke.

Likewise, the intake unit 10 may contain a filter (not shown). The intake unit may be bowl shaped as shown or take other forms. The size of the intake unit may also be varied depending on the desired usage. The intake unit may be fixedly mounted to the connecting tube or hinged such that the angle of the intake unit relative to the smoker can be adjusted. The intake unit may be made of high grade plastic, metal, fiberglass, or any other semi-rigid and heat-resistant material.

The connecting tube 20 may also be produced of high grade plastic, metal, fiberglass, or any other heat-resistant and non-porous material. The connecting tube may be flexible or rigid in the form of a hose, tube, pipe, duct, etc . . . The connecting tube may be either fixedly or removably attached to the intake unit and the air pump.

The adjustable stand 70 may be a floor stand. The stand allows for the height of the intake unit to be adjusted to be proximate to the head of the smoker. Thus, the ventilating apparatus can be used if the smoker is sitting in a chair 80 or standing. Additionally, an ashtray may be adjustably and/or removably attached to the floor stand.

A switch 60 for controlling the air flow produced by the air pump may be mounted on the stand. The switch may be a simple on/off switch or provide for variable control of the air flow. Alternately, other types of switching mechanisms may be incorporated.

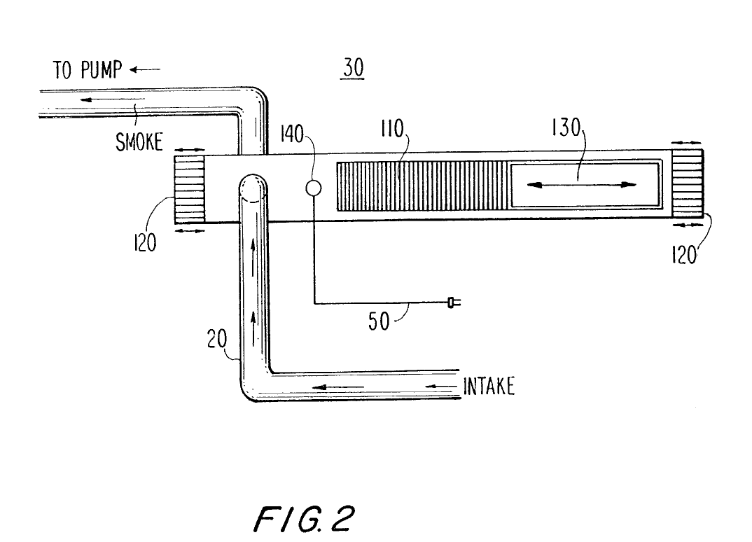

Details of the window outlet adjuster 30 are shown in FIG. 2. The window outlet adjuster 30 is adjustably mounted in a window 100 of the room. The window outlet adjuster is preferably mounted between the sill of the window and the window itself. Adjustable flaps 120 are used to adjust the width of the window outlet adjuster, thereby forming a barrier between the room and the exterior. This barrier need not be air tight, but preferably should be sufficient to prevent drafts from the window. The connecting tube 20 passes through the window outlet adjuster, thereby allowing the smoke to be drawn out. The window outlet adjuster is designed to support the connecting tube without putting any undue stresses on the tube, window, or the adjuster itself An optional hole 140 may be used to pass an electrical cord to the interior when the air pump is mounted outside. In addition, an adjustable vent 110 can be used to allow fresh air to flow through a port 130 between the room and the exterior. As with the intake unit, the window outlet adjuster may be made of high grade plastic, metal, fiberglass, or any other semi-rigid material which may also be heat resistant.

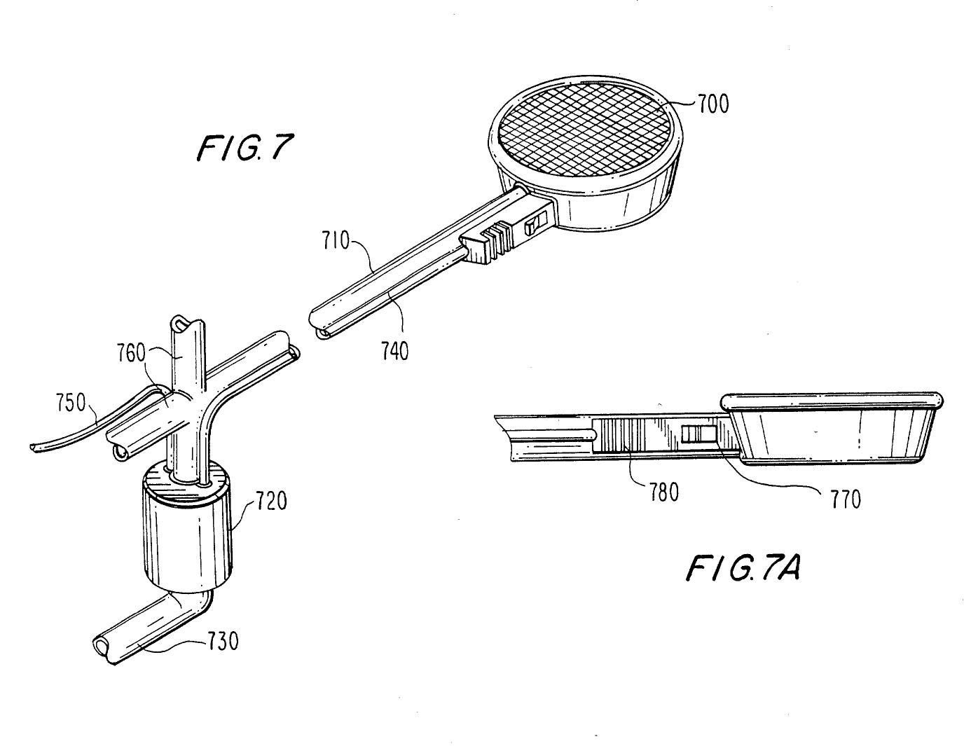

FIG. 7 is a perspective drawing showing a modification of the first embodiment of the present invention. In FIG. 7, the room ventilator has a smoke/gas suction vent 700 (corresponding to intake unit 10 in FIG. 1) for drawing in smoke exhaled by the smoker. The smoke/gas suction vent is connected by suction tube 710 (connecting tube 20) to an air suction pump 720 (air pump 40). Several suction vents may be connected to the air pump through suction tubes from various locations 760. The air suction pump produces an air flow that draws the smoke into the suction vent (intake unit) and exhausts the smoke out exhaust discharge 730 (exhaust 110). Power is supplied to the air suction pump through electric supply 750 and is controlled by wiring 740 using a switch 770. FIG. 7A is a detailed side view of the intake unit showing switch 770 and an optional smoke sensor 780. The switch can provide on/off control, variable control, and/or an automatic setting utilizing the smoke sensor.

Because only minimal assembly/installation is required, this first embodiment of the invention can be installed/removed by the user. To install the ventilating apparatus, the user simply determines whether to locate the air pump indoors or outside, mounts the window outlet adjuster in the window, feeds the connecting tube through the window adjuster, plugs in the air pump, and adjusts the location of the intake unit.

To use this first embodiment, a smoker need only adjust the height of the intake unit 10 to be in proximity to the smoker's mouth. The smoker then turns the ventilating unit on by use of the switch 60 and begins smoking. As smoke is exhaled by the smoker, it is drawn into the intake unit by the air flow produced by the air pump. The smoke travels along the connecting tube through the window outlet adjuster and is exhausted outside.

Hence, the first embodiment of the present invention allows an individual smoker to smoke indoors without adversely impacting others in the same room. In addition, the invention can be used as a general room ventilator to clear odors, dust, etc . . . from a room. This first embodiment of the invention can be produced relatively simply using well known manufacturing techniques.

Although in the above description only a single intake unit is utilized, the present invention is not so limited. Alternatively, other numbers of intake units may be used. As an example, two intake units may be used so that two smokers can smoke in a room.

Although in the above description a window outlet adjuster is used, the present invention is not so limited. Alternatively, the connecting tube can be passed directly through a wall.

Although in the above description the intake unit is mounted on a stand, the present invention is not so limited. Alternatively, the intake unit may be mounted using other means. As an example, the intake unit may be mounted from the ceiling or from a wall of the room.

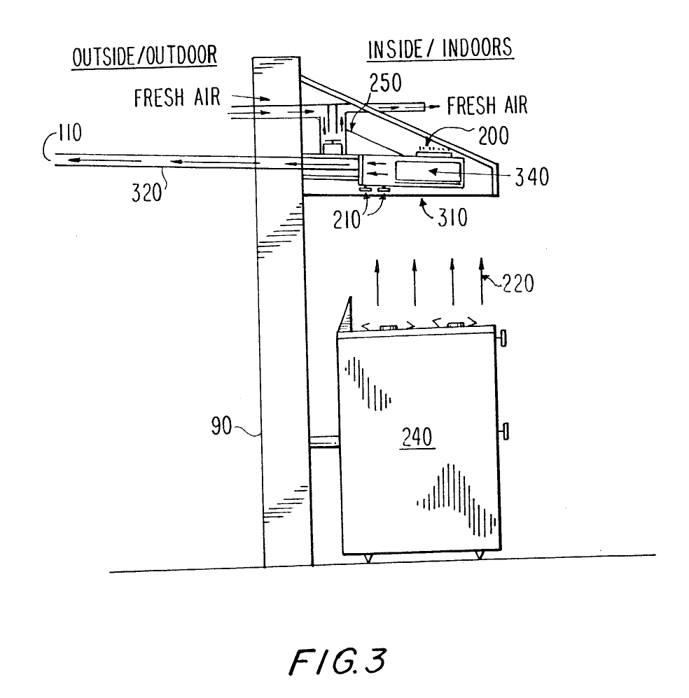

Referring to FIG. 3, a second embodiment of the invention—adapted for use indoors as a ventilating unit for detecting and venting air pollutants from a room to an exterior location—is shown. The ventilating unit has multiple sensors 210 for detecting the presence of various air pollutants 220 at an interior location and for starting an air pump 340 when an air pollutant or pollutants are detected. A duct 320 connects an intake unit 310 to the exterior location 110. The air pump 340 produces an air flow that draws the pollutant(s) into the intake unit 310 and vents the pollutant(s) at the exterior location 110.

In this second embodiment, the sensors 210 and the intake unit 310 may be located indoors such as above a natural gas appliance 240 or a table in a restaurant. The sensors 210 and the intake unit 310 may be mounted from a wall 90 in a hood type enclosure (as shown) or from the ceiling.

The sensors 210 may include two or more different types of sensors, such as two or more of a natural gas sensor, a smoke sensor, an odor sensor, a carbon monoxide sensor, and a radon sensor. The sensors act as a switching mechanism for controlling the ventilating unit. This switching mechanism may be a simple on/off switch or provide for variable control of the air flow. Alternately, other switching mechanisms such as a manual override may be incorporated. Additionally, the sensors may trigger an alarm 200 when air pollutants are detected.

The air pump 340 may be located at either an interior location as shown or outdoors (not shown). If the pump is located outside, then the pollutants are still vented through duct 320. The air pump may be mounted in a hood type enclosure (as shown) along with the sensors 210 and the intake unit 310, or separately. The air pump is preferably an electric pump. Alternatively, the air pump may be other than electrically powered (e.g. a gas or diesel pump). The air pump may also contain a filter (not shown) to filter the drawn in pollutants.

Likewise, the intake unit 3 10 may contain a filter (not shown). The size and shape of the intake unit may be varied depending on the desired usage. The intake unit may be made of high grade plastic, metal, fiberglass, or any other semi-rigid material which may also be heat-resistant.

The duct 320 may also be produced of high grade plastic, metal, fiberglass, or any other non-porous material which may also be heat-resistant. The duct may be flexible or rigid in the form of a hose, tube, pipe, etc . . .

The ventilating unit may further include a fresh air pump 250 for producing an air inflow to draw fresh air from the outside into the room. The air inflow should be positioned so that the exhausted pollutants are not drawn back in and so that the intake of air pollutants by intake unit 310 is not inhibited. The fresh air pump 250 may be located at either an interior location as shown or outdoors (not shown). The fresh air pump may be mounted in a hood type enclosure (as shown) along with the air pump 340, or mounted separately. The fresh air pump is preferably an electric pump. Alternatively, the fresh air pump may be other than electrically powered (e.g. a gas or diesel pump). The fresh air pump may also contain a filter (not shown) to filter the drawn in air.

Once installed, the ventilating apparatus operates automatically. The sensors continuously monitor for air pollutants and automatically trigger the air pump when an air pollutant or pollutants are detected. The pollutant(s) are drawn into the intake unit and vented to the outside through the duct. Operation continues until the sensors no longer detect the presence of any air pollutants and then automatically turn the ventilating unit off.

Hence, the second embodiment of the present invention allows for the automatic monitoring and ventilation of air pollutants. In addition, the invention can be used as a general room ventilator to clear odors, dust, etc . . . from a room. This second embodiment can be produced relatively simply using well known manufacturing techniques.

Although in the above description only a single intake unit is utilized, the present invention is not so limited. Alternatively, other numbers of intake units may be used. As an example, two intake units may be used to clear air pollutants from a larger portion of a room.

Although in the above description only two sensors are utilized, the present invention is not so limited. Alternatively, other numbers of sensors may be used. As an example, three sensors may be used to detect the presence of three different air pollutants.

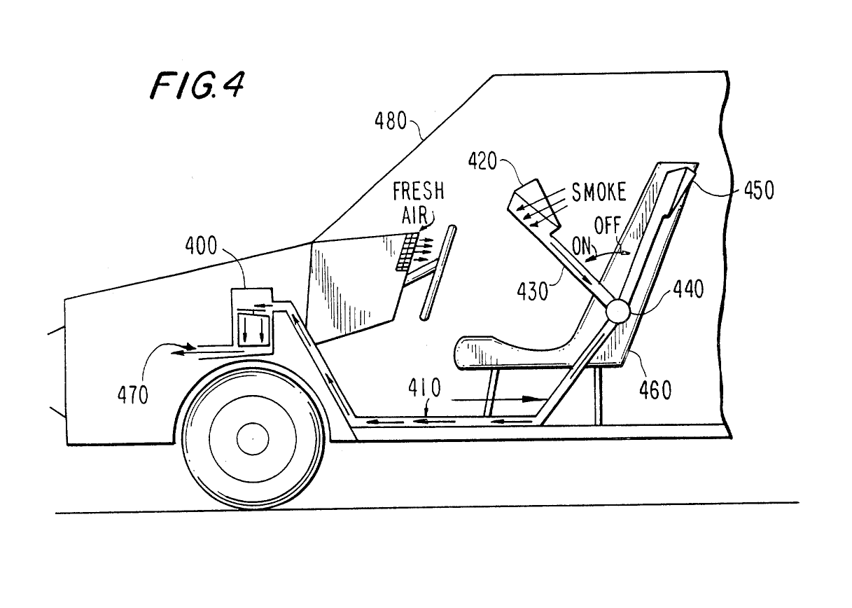

Referring to FIG. 4, a third embodiment of the present invention—adapted for use as an automobile smoke remover for removing smoke exhaled by a smoker in an automobile—is shown. The automobile smoke remover has an intake unit 420 for drawing in smoke exhaled by the smoker. The automobile smoke remover has an articulated arm 430 mounted within automobile 480. The articulated arm 430 has at least a retracted position 450 and an extended position (as shown). Intake unit 420 is mounted on the articulated arm and is located proximate to the head of the smoker for drawing in smoke exhaled when the articulated arm is in the extended position. An air pump 400 automatically produces an air flow when the articulated arm is placed in the extended position and automatically stops producing the air flow when the articulated arm is placed in the retracted position. A connecting tube 410 connects the intake unit to the outside through which the air flow passes such that the smoke drawn into the intake unit is vented 470 to the outside of the automobile.

The articulated arm 430 may be attached to a seat 460 within the automobile 480 or be supported solely by the connecting tube 410 or other means. If the articulated arm 430 is attached to a seat, then it may be attached at switch hinge 440. Switch hinge 440 acts as a switching mechanism for controlling the automobile smoke remover depending upon the position of the articulated arm as described above. The switch hinge 440 may be a simple on/off switch. Alternately, other switching mechanisms such as a manual override that provides for variable control of the air flow may be incorporated. The articulated arm may be made of high grade plastic, metal, fiberglass, or any other semi-rigid material which may also be heat-resistant.

The air pump 400 may be located outside the passenger compartment of the automobile as shown or beneath the seat to which the articulated arm is attached. If the pump is located outside the passenger compartment, then it is preferably located in either the engine compartment or the trunk. The air pump is preferably an electric pump powered by the automobile battery which may be tied directly into the automobile's power system or simply plugged into a standard automobile electrical receptacle (e.g. cigarette lighter). The air pump may also contain a filter (not shown) to filter the drawn in smoke.

Likewise, the intake unit 420 may contain a filter (not shown). The intake unit may be bowl shaped as shown or take other forms. The size of the intake unit may also be varied. The intake unit may be fixedly mounted to the articulated arm 430 or hinged such that the angle of the intake unit relative to the smoker can be adjusted. The intake unit may also be mounted on the distal end of the articulated arm or be adjustable along the length of the articulated arm. The intake unit may be made of high grade plastic, metal, fiberglass, or any other semi-rigid material which may also be heat-resistant.

The connecting tube 410 may also be produced of high grade plastic, metal, fiberglass, or any other non-porous material which may also be heat-resistant. The connecting tube may be flexible or rigid in the form of a hose, tube, pipe, duct, etc . . . The connecting tube may be either fixedly or removably attached to the intake unit and the air pump.

In this third embodiment, the automobile smoke remover may alternatively include a window outlet adjuster (not shown) for mounting in a window of the automobile and connecting to the connecting tube to exhaust the smoke from the automobile.

The automobile smoke remover can be installed either by an automobile manufacturer during assembly of the automobile or as an after-market accessory. If the automobile smoke remover is to be installed by a user as an after-market product, the user simply determines which seat to install the unit on, mounts the articulated arm and the air pump, feeds the connecting tube, plugs in the air pump (such as to a cigarette lighter slot), and adjusts the location of the intake unit.

To use this third embodiment, a smoker need only extend the articulated arm 430 and, if appropriate, adjust the intake unit 420, so that the intake unit is in proximity to the smoker's mouth. The switch hinge 440 automatically turns the unit on. The smoker can then begin smoking. As smoke is exhaled by the smoker, it is drawn into the intake unit by the air flow produced by the air pump. The smoke travels along the connecting tube and is exhausted outside the passenger compartment.

Hence, the third embodiment of the invention allows for an individual smoker to smoke inside an automobile without adversely impacting others in the same car. In addition, the invention can be used as a general ventilator to clear odors, dust, etc . . . from the car. This third embodiment can be produced relatively simply using well known manufacturing techniques.

Although in the above description only a single automobile smoke remover is mentioned, the present invention is not so limited. Alternatively, multiple automobile smoke removers may be used in the same car. As an example, an automobile smoke remover can be used by the driver and another automobile smoke remover can be used by a passenger.

Although in the above description the articulated arm is mounted/hinged from the side of the seat, the present invention is not so limited. Alternatively, the articulated arm may be mounted using other means. As an example, the articulated arm may be mounted from the floor of the automobile or from the top of the seat.

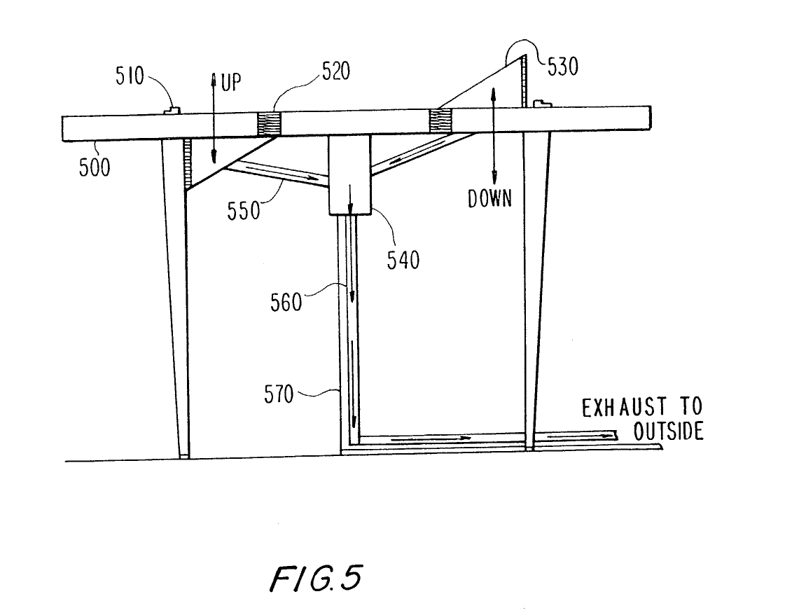

FIG. 5 is a diagram showing a fourth embodiment of the present invention adapted for use indoors as a room ventilator integrated into a table 500 for venting smoke exhaled by a smoker from a room to an exterior location. The room ventilator has a number of pop-up smoke suction vents 530 for drawing in smoke exhaled by a smoker or smokers. The smoke suction vents 530 retract into the tabletop when not in use. The retracting action for the smoke suction vents can be manual or spring/motor 520 actuated. An air suction pump 540 produces an air flow that draws the smoke into the smoke suction vents and exhausts the smoke through exhaust pipe 560 to the outside. A connecting pipe 550 connects the smoke suction vents to the air suction pump. The pump is powered electrically through a simple power chord 570.

A switch 510 is provided for each smoke suction vent for controlling the air flow produced by the air suction pump and/or the retraction mechanism. The switch may be a simple on/off switch or provide for variable control. Alternately, other types of switching mechanisms may be incorporated.

This fourth embodiment may come pre-assembled as a piece of furniture. To install the room ventilator, the user simply determines where to locate the table, feeds the connecting pipe to an outside location (e.g. through a window), and plugs in the air suction pump.

To use this fourth embodiment, a smoker need only pop-up the vent at the position in which he or she is seated at the table, turn the ventilating unit on by use of the switch and begin smoking. As smoke is exhaled by the smoker, it is drawn into the respective smoke suction vent by the air flow produced by the air suction pump. The smoke travels along the connecting pipe and is exhausted outside.

Hence, the fourth embodiment allows for an individual smoker seated at a table to smoke indoors without adversely impacting others in the same room. In addition, the present ventilator can be used as a general room ventilator to clear odors, dust, etc . . . from a room. This fourth embodiment can be produced relatively simply using well known manufacturing techniques.

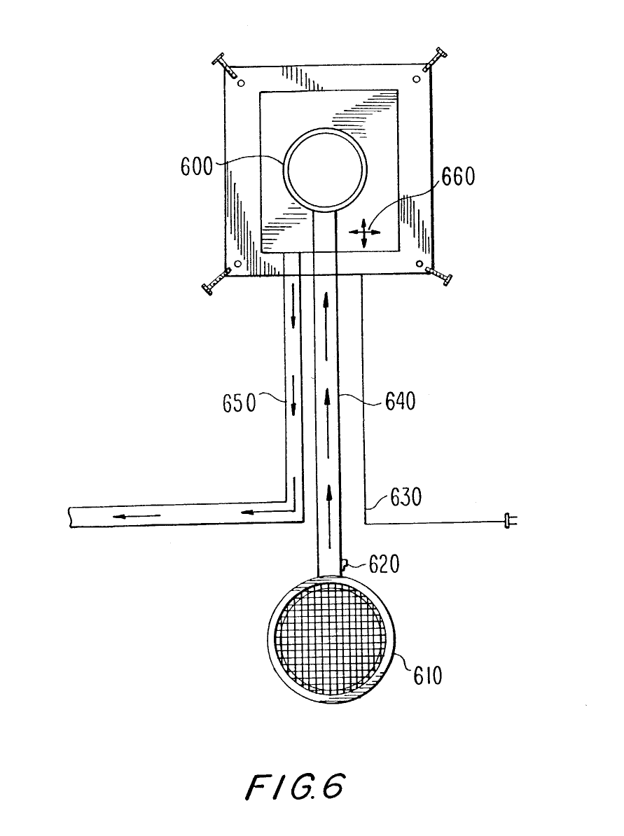

FIG. 6 is a diagram showing a fifth embodiment of the present invention adapted for use indoors as a room ventilator for venting smoke exhaled by a smoker from a room to an exterior location. The room ventilator has a smoke suction vent 610 (corresponding to intake unit 10 in FIG. 1) for drawing in smoke exhaled by the smoker. The smoke suction vent is adjustably mounted 660 to a mounting plate which screws into the wall through moveable connecting pipe 640 to be located proximate to the head of the smoker. An air suction pump 600 is mounted inside the wall to produce an air flow for drawing the smoke into the smoke suction vent and exhaust the smoke through a pipe 650 to the outside.

The air suction pump is preferably an electric pump powered using a simple electrical supply 630 which may be plugged into any standard electrical receptacle. Alternatively, the air suction pump may be other than electrically powered (e.g. a gas or diesel pump). The air suction pump may also contain a filter (not shown) to filter the drawn in smoke.

Likewise, the smoke suction vent 610 may contain a filter (not shown). The smoke suction vent may be bowl shaped as shown or take other forms. The size of the smoke suction vent may also be varied depending on the desired usage. The smoke suction vent may be fixedly mounted to the connecting tube or hinged such that the angle of the suction vent relative to the smoker can be adjusted. The suction vent may be made of high grade plastic, metal, fiberglass, or any other semi-rigid material which may be heat-resistant.

The moveable connecting pipe 640 may be attached to the wall using a hinged mount that provides for multiple fixed positions of the suction vent. The moveable connecting pipe 640 may also be produced of high grade plastic, metal, fiberglass, or any non-porous material which may be heat-resistant. The moveable connecting pipe may be rigid, and may be in the form of a hose, tube, pipe, duct, etc . . . The moveable connecting pipe may be either fixedly or removably attached to the suction vent and the air suction pump.

A switch 620 for controlling the air flow produced by the air pump may be mounted on the pipe 640. The switch may be a simple on/off switch or provide for variable control of the air flow. Alternately, other types of switching mechanisms may be incorporated.

To use this fifth embodiment, a smoker need only adjust the height of the smoke suction vent 610 to be in proximity to the smoker's mouth. The smoker then turns the ventilating unit on by use of the switch 620 and begins smoking. As smoke is exhaled by the smoker, it is drawn into the smoke suction vent by the air flow produced by the air suction pump. The smoke travels along the moveable connecting tube and through the exhaust to the outside.

Hence, the fifth embodiment allows for an individual smoker to smoke indoors without adversely impacting others in the same room. In addition, such embodiment can be used as a general room ventilator to clear odors, dust, etc . . . from a room. This fifth embodiment can be produced relatively simply using well known manufacturing techniques.

Although in the above description only a single smoke section vent is utilized, the present invention is not so limited. Alternatively, other numbers of smoke suction vents may be mounted to various wall units around a room. As an example, two smoke suction vents may be mounted to two different wall units which may share a single air suction pump, so that two smokers can smoke in a room.

While preferred embodiments of the present invention have been described using specific terms, such descriptions are for illustrative purposes only, and it is to be understood that changes and variations may be made without departing from the spirit or scope of the following claims.

What is claimed is:

1. A room ventilator comprising:
an intake unit located in a room adapted to draw in smoke exhaled by a smoker;
an air pump producing an air flow to draw said smoke into said intake unit and exhaust said smoke to an exterior location;
connecting means including at least one connecting tube connecting said intake unit to said air pump so that the smoke drawn into said intake unit is conducted to said exterior location; and
a window outlet adjuster adapted to be mounted in a window which enables said connecting tube to pass from said room to said exterior location, said window outlet adjuster having adjustable flaps to form a barrier between said room and the exterior;
whereby, smoke exhaled by said smoker is-vented from said room to said exterior location.

2. The room ventilator according to claim 1, wherein said intake unit being located proximate to the head of said smoker.

3. The room ventilator according to claim 1, further comprising a floor stand for supporting said intake unit proximate to the head of said smoker.

4. The room ventilator according to claim 1, further comprising a variable switch for controlling the air flow produced by said air pump.

5. The room ventilator according to claim 1, wherein said window outlet adjuster includes adjustable vents to allow air to flow between said room and the exterior.

6. The room ventilator according to claim 1, wherein said air pump is located at said exterior location.

7. The room ventilator according to claim 1, wherein said air pump is located within said room.

8. The room ventilator according to claim 1, wherein said connecting tube is a flexible hose.

9. A ventilating unit comprising:
an air pump producing an air flow;
first and second sensors each adapted to respectively detect the presence of first and second air pollutants at an interior location and to start said air pump when at least one of said first and second air pollutants is detected, in which said first air pollutant is different from said second air pollutant;
an intake unit adapted to use said air flow to draw in the detected air pollutant(s) at said interior location; and
a duct connecting said intake unit to an exterior location and adapted to have said air flow pass therethrough such that the detected air pollutant(s) drawn into said intake unit are vented to an exterior location.

10. The ventilating unit according to claim 9, wherein said first and second sensors include at least two of a natural gas sensor, a smoke sensor, an odor sensor, a carbon monoxide sensor, and a radon sensor.

11. The ventilating unit according to claim 9, wherein said plurality of sensors produce an alarm signal when air pollutant(s) are detected.

12. The ventilating unit according to claim 9, further comprising a fresh air pump for producing an air inflow to draw fresh air from said exterior location into said interior location.

13. The ventilating unit according to claim 9, wherein said sensors and said intake unit are located above a natural gas appliance.

14. The ventilating unit according to claim 9, wherein said sensors and said intake unit are mounted above a table in a restaurant.

15. An automobile smoke remover for removing smoke exhaled by a smoker in an automobile, comprising:
an articulated arm mounted within said automobile and having at least a retracted position and an extended position;
an intake unit mounted on said articulated arm, said intake unit being located proximate to the head of said smoker for drawing in smoke exhaled by said smoker when said articulated arm is in the extended position;
an air pump adapted to automatically produce an air flow when said articulated arm is placed in the extended position and to automatically stop producing said air flow when said articulated arm is placed in the retracted position; and
connecting means including at least one connecting tube connecting said intake unit to the outside and adapted to have said air flow pass therethrough such that the smoke drawn into said intake unit is vented to the outside of said automobile.

16. The automobile smoke remover according to claim 15, further comprising a window outlet adjuster connected to said connecting tube for exhausting said smoke from said automobile, said window outlet adjuster being mounted in a window of said automobile.

17. The automobile smoke remover according to claim 15, wherein said automobile smoke remover is installed after-market.

18. The automobile smoke remover according to claim 15, wherein said air pump is located beneath a seat in said automobile to which said articulated arm is attached.

19. A room ventilating apparatus comprising:
intake means located in a room for drawing in smoke exhaled by a smoker;
air pumping means for producing an air flow to draw said smoke into said intake means and for exhausting said smoke to an exterior location;
conducting means connecting said intake means to said air pumping means for conducting the smoke drawn into said intake means to said exterior location; and
window outlet means mounted in a window for enabling said conducting means to conduct the smoke from said room to said exterior location, said window outlet means having adjustable flaps for forming a barrier between said room and the exterior;
whereby, smoke exhaled by said smoker is vented from said room to said exterior location.

20. A ventilating apparatus comprising:
air pumping means for producing an air flow;
first and second sensing means for respectively detecting the presence of first and second air pollutants at an interior location and for starting said air pump when at least one of said first and second air pollutants is detected, in which said first air pollutant is different from said second air pollutant;
intake means for using said air flow to draw in the detected air pollutant(s) at said interior location; and
conducting means connecting said intake means to an exterior location for passing said air flow therethrough such that the detected air pollutant(s) drawn into said intake means are vented to an exterior location.
